(19) United States
(12) Patent Application Publication
(10) Pub. No.: US 2002/0196925 A1
(43) Pub. Date: Dec. 26, 2002

(54) Communication apparatus, private branch exchange apparatus, maintenance terminal apparatus, and simulation method

(75) Inventors: Shuji Yamazaki, Koganei-shi (JP); Shuji Fujitsuka, Hino-shi (JP)

Correspondence Address: Finnegan, Henderson, Farabow,, Garrett & Dunner, L.L.P., 1300 I Street, N.W., Washington, DC, 20005-3315, US

(73) Assignee: KABUSHIKI KAISHA TOSHIBA

(21) Appl. No.: 10/175,870

(22) Filed: Jun. 21, 2002

(30) Foreign Application Priority Data
Jun. 21, 2001 (JP) 2001-188688
Jun. 28, 2001 (JP) 2001-196498

(51) Int. Cl. H04M 7/00

(52) U.S. Cl. 379/226

(57) ABSTRACT

A simulation program in which a step of allowing a maintenance terminal to simulate control process contents concerning an exchange among a plurality of extension terminals written in an application program is written is stored in a storage section disposed in a private branch exchange apparatus, and a CPU displays a model indicating the plurality of extension terminals and the whole private branch exchange apparatus in a display of the maintenance terminal and allows the maintenance terminal to operate based on the simulation program stored in the storage section and execute the control process contents written in the application program with respect to the model displayed in the display, when a simulation mode is set.

### CROSS-REFERENCE TO RELATED APPLICATIONS

This application is based upon and claims the benefit of priority from the prior Japanese Patent Applications No. 2001-188688, filed Jun. 21, 2001; and No. 2001-196498, filed Jun. 28, 2001, the entire contents of both of which are incorporated herein by reference.

### BACKGROUND OF THE INVENTION

1. Field of the Invention

The present invention relates to a communication apparatus for performing a predetermined communication process, a private branch exchange apparatus for controlling exchanges, for example, among a plurality of extension terminals, a maintenance terminal apparatus for simulating an operation of the private branch exchange apparatus, and a simulation method.

2. Description of the Related Art

A large number of private branch exchange apparatuses have heretofore been used in office buildings and business places. In this type of the private branch exchange apparatus, extension terminals such as telephone sets are disposed, and the extension terminal and external communication network such as a public network, or the extension terminals are mutually exchanged/connected so that telephone calls are possible.

Additionally, for this private branch exchange apparatus, it is necessary to execute a daily exchange process for many years without interruption, and therefore a long-term stable operation is required. To achieve this, for example, test operators have heretofore conducted a connection test of the extension terminal, or a stabilization test for checking normality of hardware of the private branch exchange apparatus to check a path of time switch before starting the operation or during maintenance/inspection of the private branch exchange apparatus.

Additionally, this conventional private branch exchange apparatus has the following problem to solve. That is, to conduct the stabilization test, it is necessary to perform various services using hardware, and it is therefore necessary to set data. Therefore, the test operator has to set the data for performing various services, subsequently operate the extension terminal and execute an objective service. The test requires much time, and an operation mistake is easily generated. As a result, efficiency and reliability of the test are deteriorated. Moreover, since the test is a simple repetitive operation, a burden onto the test operator is large. Furthermore, when a maximum value test is performed using a conference circuit, it is necessary to operate all the terminals, and this is a laborious operation.

Moreover, with a trouble generated in the private branch exchange apparatus in a user place of an actually operated system, the test operator faithfully reproduces user's conditions under which the trouble has been generated, such as user's function setting contents, the number of connected terminals, and the number of contained lines, analyzes reproduced results, and takes countermeasures against the trouble, such as modification of the function setting contents based on the analysis result.

On the other hand, to handle a large number of contained lines or connected terminals, the test operator specifies a trouble generation factor (minimum required function setting method, the number of connected terminals).

Therefore, the test operator has to collect trouble contents or user data, construct a facility having a state similar to a user state, reproduce a state of the system of a time when the trouble is generated, and specify/check troubles such as the minimum required function setting and the number of connected terminals. There is a problem that it takes much time and labor to reproduce the trouble generated at the user place.

### BRIEF SUMMARY OF THE INVENTION

An object of the present invention is to provide a communication apparatus, private branch exchange apparatus, maintenance terminal apparatus, and simulation method in which an operation test in a control object can accurately be executed with a simple operation by an extend control apparatus in a short time, efficiency and reliability of the test are thereby enhanced, and a burden onto a test operator can remarkably be reduced.

According to one aspect of the present invention, there is provided a communication apparatus which executes a predetermined communication process and controls a control object related with communication based on an application program stored in first storing means, the communication apparatus comprising:

Connecting means for connecting an extend control apparatus disposed outside the apparatus and including a display; second storing means for storing a simulation program in which a step of allowing the extend control apparatus to simulate control process contents written in the application program is written; and simulation controlling means for making the extend control apparatus display a model indicating the control object in the display, execute the control process contents written in the application program with respect to the model displayed in the display in accordance with the simulation program, when a simulation by the extend control apparatus is designated.

According to another aspect of the present invention, there is provided a private branch exchange apparatus which connects a plurality of extension terminals via extension lines, and executes a control over an exchange among the plurality of extension terminals based on an application program stored in first storing means, the private branch exchange apparatus comprising:

Connecting means for connecting an extend control apparatus disposed outside the apparatus and including a display; second storing means for storing a simulation program in which a step of allowing the extend control apparatus to simulate control process contents concerning the exchange written in the application program is written; and simulation controlling means for making the extend control apparatus display a model indicating at least the plurality of extension terminals in the display, execute the control process contents written in the application program with respect to the model displayed in the display in accordance with the simulation program, when a simulation by the extend control apparatus is designated.

Moreover, according to further aspect of the present invention, there is provided a communication apparatus which executes a predetermined communication process, and controls a predetermined control object related with communication, the communication apparatus comprising:

Connecting means for connecting an extend control apparatus disposed outside the apparatus; storing means for storing a simulation program in which a step of performing the communication process in the extend control apparatus is written; and simulation controlling means for making the extend control apparatus execute a control process of the control object in accordance with the simulation program, when the control process of the control object by the extend control apparatus connected to the connection means is designated.

Furthermore, according to still further aspect of the present invention, there is provided a private branch exchange apparatus which connects a plurality of extension terminals via extension lines, and executes a control over an exchange among the plurality of extension terminals, the private branch exchange apparatus comprising:

Connecting means for connecting an extend control apparatus disposed outside the apparatus; storing means for storing a simulation program in which a step of executing a control process concerning the exchange among the plurality of extension terminals in the extend control apparatus is written; and simulation controlling means for making the extend control apparatus execute the control process concerning the exchange among the plurality of extension terminals in accordance with the simulation program, when the control process by the extend control apparatus is designated.

### BRIEF DESCRIPTION OF THE SEVERAL VIEWS OF THE DRAWING

FIG. 1 is a schematic constitution diagram showing one embodiment of a private branch exchange system to which a private branch exchange apparatus according to the present invention is applied.

FIG. 2 is an explanatory view of an operation during setting of a simulation mode in the system shown in FIG. 1.

FIG. 3 is a flowchart showing a control step and contents of a CPU shown in FIG. 1.

FIGS. 4A to 4D are diagrams showing one example of a display screen in a maintenance terminal shown in FIG. 1.

FIGS. 5A to 5D are diagrams showing one example of the display screen in the maintenance terminal shown in FIG. 1.

FIGS. 6A to 6D are diagrams showing one example of the display screen in the maintenance terminal shown in FIG. 1.

FIG. 7 is a schematic constitution diagram showing a second embodiment of the private branch exchange system to which the private branch exchange apparatus according to the present invention is applied.

FIG. 8 is an explanatory view of the operation during the setting of the simulation mode in the system shown in FIG. 7.

FIG. 9 is a flowchart showing the control step and contents of the maintenance terminal shown in FIG. 7.

FIG. 10 is a sequence diagram showing an operation among the maintenance terminal, private branch exchange apparatus and extension terminal during the performing of a conference call.

FIG. 11 is a schematic constitution diagram showing a third embodiment of the private branch exchange system to which the private branch exchange apparatus according to the present invention is applied.

FIG. 12 is a block diagram showing a main constitution of the maintenance terminal shown in FIG. 11.

FIG. 13 is a flowchart showing the control step and contents of the CPU shown in FIG. 12.

FIG. 14 is a schematic constitution diagram showing a fourth embodiment of the private branch exchange system to which the private branch exchange apparatus according to the present invention is applied.

FIG. 15 is a block diagram showing a main constitution of the maintenance terminal shown in FIG. 14.

### DETAILED DESCRIPTION OF THE INVENTION

Embodiments of the present invention will be described hereinafter in detail with reference to the drawings.

### First Embodiment

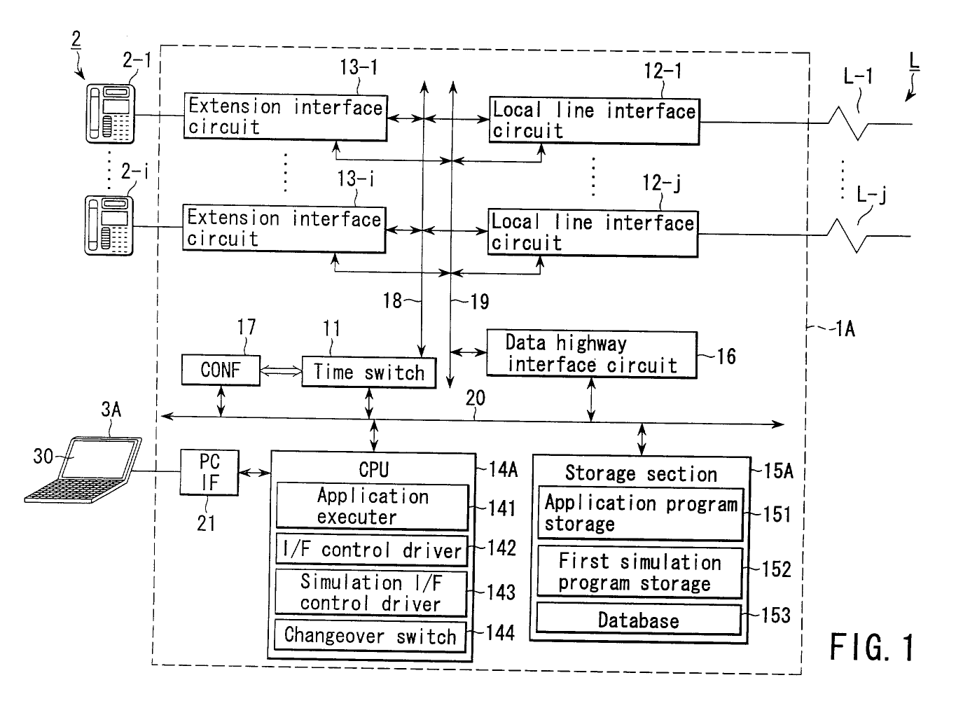

FIG. 1 is a schematic constitution diagram showing a first embodiment of a private branch exchange system to which a private branch exchange apparatus according to the present invention is applied.

As shown in FIG. 1, the private branch exchange system is constituted by arbitrarily connecting a private branch exchange apparatus 1A to a plurality of (i at maximum) extension terminals 2 (2-1 to 2-i).

The private branch exchange apparatus 1A further includes: a time switch 11; a plurality of (j) local line interface circuits 12 (12-1 to 12-j); a plurality of (i) extension interface circuits 13 (13-1 to 13-i); a CPU 14A; a storage section 15A; a data highway interface circuit 16; and a conference circuit 17. The time switch 11, local line interface circuits 12 and extension interface circuits 13 are connected to one another via a PCM highway 18.

Moreover, the local line interface circuits 12, extension interface circuits 13 and data highway interface circuit 16 are connected to one another via a data highway 19. Furthermore, the time switch 11, CPU 14A, storage section 15A, data highway interface circuit 16 and conference circuit 17 are connected to one another via a CPU bus 20.

The time switch 11 arbitrarily exchanges/connects the extension interface circuits 13, and the local line interface circuits 12 with the extension interface circuits 13 based on a control of the CPU 14A.

The local line interface circuits 12 are connected to local lines L (L-1 to L-j) such as a public network and private line if necessary. The local line interface circuits 12 perform local line interface operations concerning the connected local lines L. The local line interface operations include conversion of sound signals (analog) given via the local lines L to PCM signals, conversion of the PCM signal given via the time switch 11 to the sound signal (analog), state monitor of the local lines L, and the sending of various signals to the network connected via the local lines L. Moreover, the local line interface circuits 12 transmit/receive various types of control information concerning the local line interface operations with respect to the CPU 14A via the data highway 19, data highway interface circuit 16 and CPU bus 20.

The extension interface circuits 13 are connected to the extension terminals 2 if necessary. The extension interface circuits 13 perform extension interface operations concerning the connected extension terminals 2. The extension interface operations include extraction of the PCM signals outputted from the extension terminals 2 via the PCM highway 18, state monitor of the extension terminals 2, and sending of various signals to the extension terminals 2. Moreover, the extension interface circuits 13 transmit/receive various types of control information concerning the extension interface operations with the CPU 14A via the 19, data highway interface circuit 16 and CPU bus 20.

The data highway interface circuit 16 transmits/receives the data between the data highway 19 and CPU bus 20.

The conference circuit 17 calls speakers of other extension lines or local lines, for example, from the extension terminal 2-2, so that a conference call among three or more speakers is possible.

Additionally, the storage section 15A of the first embodiment includes an application program storage 151, first simulation program storage 152, and database 153. Moreover, the CPU 14A is connected to a computer interface section (PCIF) 21.

The computer interface section 21 is connected to a maintenance terminal 3A if necessary. The computer interface section 21 performs an interface operation concerning the connected maintenance terminal 3A. The interface operation includes extraction of an output signal from the maintenance terminal 3A, state monitor of the maintenance terminal 3A, and sending of various signals to the maintenance terminal 3A. Moreover, the computer interface section 21 transmits/receives various types of control information on the interface operation with the CPU 14A.

In the first simulation program storage 152 of the storage section 15A, there is stored a simulation program in which a step of allowing the maintenance terminal 3A to simulate control process contents concerning the exchange among a plurality of extension terminals 2 written in the application program is written.

In the database 153, function setting information used by the CPU 14A is stored.

On the other hand, the CPU 14A includes an application executor 141, interface (I/F) control driver 142, simulation interface (I/F) control driver 143, and changeover switch 144. The application executor 141 performs a process based on the application program stored in the application program storage 151 of the storage section 15A, overall controls the time switch 11, local line interface circuits 12 and extension interface circuits 13, and realizes the operation of the private branch exchange apparatus 1A.

The interface control driver 142 transmits/receives the data with the application executor 141, time switch 11, data highway interface circuit 16 and conference circuit 17 via an OS/driver layer.

The simulation interface control driver 143 allows the maintenance terminal 3A to display the model indicating at least a plurality of extension terminals 2 and the whole private branch exchange apparatus 1A in a display 30. Simultaneously, the driver allows the terminal to operate based on the simulation program stored in the first simulation program storage 152 of the storage section 15A and to execute the control process contents written in the application program with respect to the model displayed in the display 30.

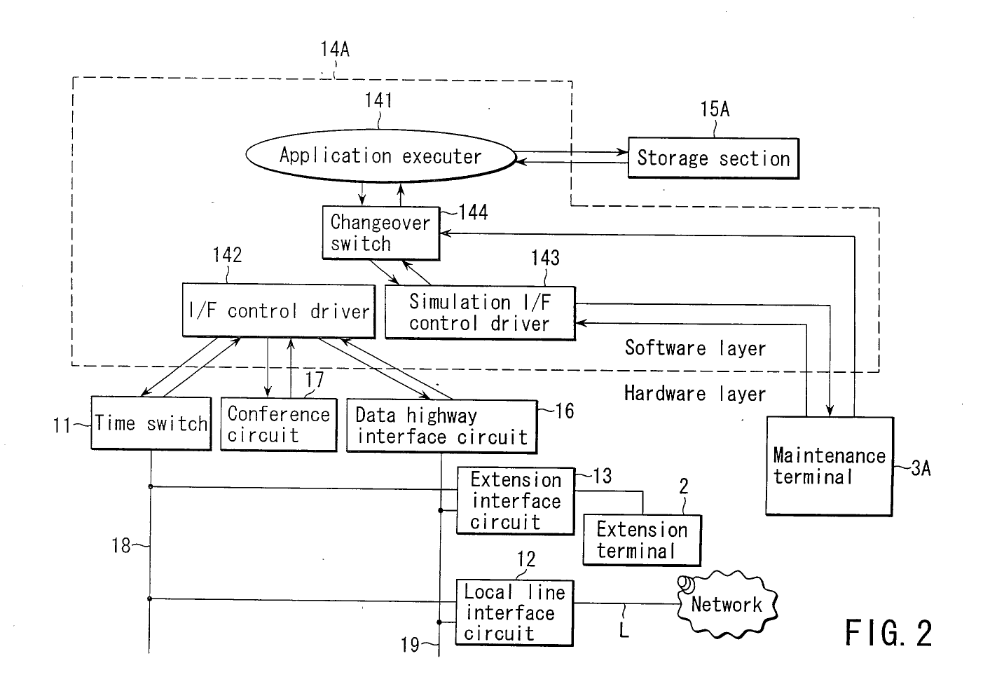

The changeover switch 144 selectively changes two process modes by a software process in response to a mode designation operation from the maintenance terminal 3A as shown in FIG. 2. One of two process modes is a usual mode in which the CPU 14A executes a control over the exchange among a plurality of extension terminals 2 based on the application program stored in the application program storage 151 of the storage section 15A. Moreover, the other mode is a simulation mode in which the maintenance terminal 3A operates based on the simulation program stored in the first simulation program storage 152 of the storage section 15A and executes the control process contents written in the application program with respect to the model displayed in the display 30.

An operation of the private branch exchange apparatus 1A constituted as described above will next be described.

### Usual Simulation Operation

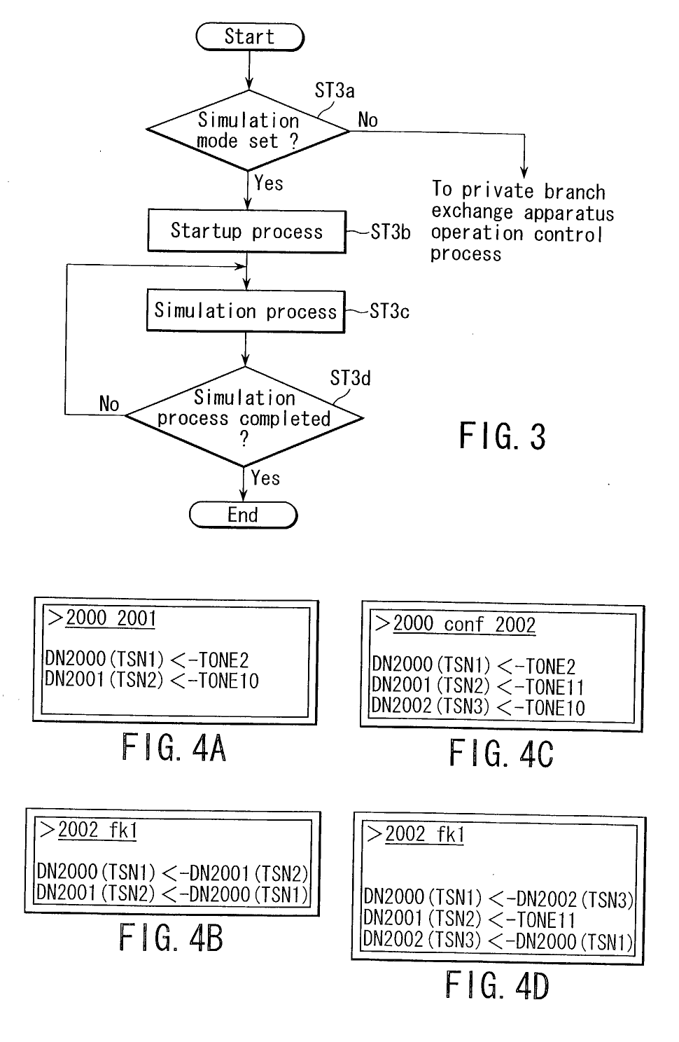

When the maintenance terminal 3A is connected to the private branch exchange apparatus 1A, the CPU 14A of the private branch exchange apparatus 1A starts a control process shown in FIG. 3.

When starting this control process, the CPU 14A first checks the state of the changeover switch 144, and judges whether or not the switch is set to the simulation mode (step ST3a).

Subsequently, when the usual mode is set, the CPU 14A shifts to a private branch exchange apparatus operation control process for realizing an original operation of the private branch exchange apparatus 1A such as the exchanging/connecting of the extension terminals based on the application program stored in the application program storage 151 of the storage section 15A.

On the other hand, when the simulation mode is set, the CPU 14A executes the following process based on the simulation program stored in the first simulation program storage 152 of the storage section 15A.

That is, the CPU 14A allows the maintenance terminal 3A to execute a known startup process (step ST3b), display a model indicating the whole private branch exchange apparatus 1A and extension terminals 2 in the display 30, and execute written contents of the application program stored in the application program storage 151 with respect to the model (step ST3c).

During the execution, the maintenance terminal 3A selectively executes any one of a series of operation control step based on the simulation program and an operation control step designated by the operation of the test operator with respect to the model displayed in the display 30.

Subsequently, the CPU 14A judges whether or not a simulation process has been completed with respect to the maintenance terminal 3A, and repeatedly executes the process of the steps ST3c and ST3d until the process is completed.

Moreover, the CPU 14A ends the process, when the simulation process is completed with respect to the maintenance terminal 3A.

As described above, data similar to data of the operation of the extension terminals 2 and lines is inputted via the maintenance terminal 3A so that the operation contents of an actual application can be verified.

### Conference Call Operation

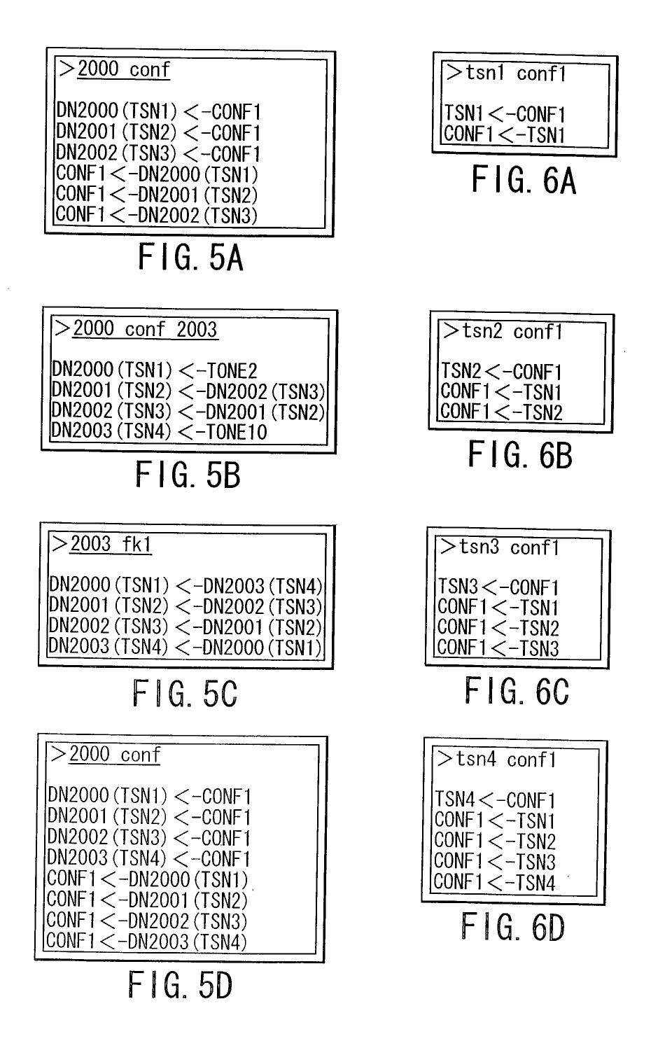

FIGS. 4 and 5 are screen diagrams showing operation examples of conference calls displayed in the display 30 of the maintenance terminal 3A.

It is assumed that to perform the simulation the test operator performs an operation of using the maintenance terminal 3A to call the extension terminal 2-2 having extension number “2001” via the extension terminal 2-1 having extension number “2000”. Then, a screen shown in FIG. 4A is displayed in the display 30. Additionally, in FIG. 4A, TSN1, 2 denote time slot numbers of the extension numbers “2000”, “2001”, TONE2 denotes a ring back tone, and TONE10 denotes an incoming call tone. Here, a state is shown in which the speaker of extension number “2000” hears the ring back tone, and the speaker of the extension number “2001” hears the incoming call tone.

Subsequently, when the extension terminal 2-2 with the extension number “2001” answers the call, the screen shown in FIG. 4B is displayed in the display 30. In this manner, a communication path is formed between the extension terminal 2-1 as a caller and the extension terminal 2-2 as a destination, and thereafter talking is possible between the extension terminals 2-1, 2-2.

It is assumed that in a state of the talking between the extension terminals 2-1, 2-2, the test operator uses the maintenance terminal 3A to perform an operation of calling the extension terminal 2-3 with an extension number “2002” from the extension terminal 2-1. Then, the display 30 displays a screen shown in FIG. 4C. Additionally, in FIG. 4C, TONE11 indicates a hold tone. Here, the speaker with the extension number “2001” hears the hold tone, the speaker with the extension number “2000” hears the ring back tone, and the speaker with the extension number “2002” hears the incoming call tone.

Subsequently, when the extension terminal 2-3 with the extension number “2002” answers the call, the display 30 displays a screen shown in FIG. 4D. Moreover, while the extension terminal 2-2 is held, a communication path is formed between the extension terminals 2-1 and 2-3. In this manner, the destination of the extension terminal 2-1 is changed over to the extension terminal 2-3 from the extension terminal 2-2, and thereafter the talking is possible between the extension terminals 2-1, 2-3.

It is assumed that in this state the test operator uses the maintenance terminal 3A to require a conference from the extension terminal 2-1. Then, the display 30 displays a screen shown in FIG. 5A, and a conference is possible among the extension terminals 2-1, 2-2, 2-3. Additionally, in FIG. 5A, CONF1 indicates a conference circuit number 1. Here, the conference circuit number 1 is used to indicate a three-speakers conference state.

It is assumed that in a state of the conference performed among the extension terminals 2-1, 2-2, 2-3, the test operator uses the maintenance terminal 3A to call the extension terminal 2-4 with an extension number “2003” from the extension terminal 2-1. Then, the display 30 displays a screen shown in FIG. 5B. Here, a state is shown in which the extension numbers “2001”, “2002” are in the talking state, the speaker with the extension number “2000” hears the ring back tone, and the speaker with the extension number “2003” hears the incoming call tone.

Subsequently, when the extension terminal 2-3 with the extension number “2003” answers the call, the display 30 displays a screen shown in FIG. 5C. Moreover, the communication path is formed between the extension terminals 2-1 and 2-4. Therefore, the talking is possible between the extension terminals 2-1 and 2-4, and between the extension terminals 2-2 and 2-3.

It is assumed that in this state the test operator uses the maintenance terminal 3A to require the conference from the extension terminal 2-1. Then, the display 30 displays a screen shown in FIG. 5, and a four-speakers conference is possible among the extension terminals 2-1, 2-2, 2-3, 2-4.

FIG. 6 show screen diagrams showing other operation examples of the conference call displayed in the display 30 of the maintenance terminal 3.

It is assumed that to perform the simulation the test operator uses the maintenance terminal 3A to perform an operation of connecting the extension terminal 2-1 to the conference circuit 17 with the conference circuit number 1. Then, a screen shown in FIG. 6A is displayed in the display 30.

Subsequently, it is assumed that the user uses the maintenance terminal 3A to perform an operation of connecting the extension terminal 2-2 to the conference circuit 17 with the conference circuit number 1. Then, a screen shown in FIG. 6B is displayed in the display 30. Therefore, the talking is possible between the extension terminals 2-1 and 2-2.

Moreover, it is assumed that the user uses the maintenance terminal 3A to perform an operation of connecting the extension terminal 2-3 to the conference circuit 17 with the conference circuit number 1. Then, a screen shown in FIG. 6C is displayed in the display 30. Therefore, the three-speakers talking is possible among the extension terminals 2-1, 2-2, 2-3.

Furthermore, it is assumed that the user uses the maintenance terminal 3A to perform an operation of connecting the extension terminal 2-4 to the conference circuit 17 with the conference circuit number 1. Then, a screen shown in FIG. 6D is displayed in the display 30. Therefore, the four-speakers talking is possible among the extension terminals 2-1, 2-2, 2-3, 2-4.

As described above, according to the first embodiment, in the storage section 15A disposed in the private branch exchange apparatus 1A, there is stored the simulation program in which the step of allowing the maintenance terminal 3A to simulate the control process contents concerning the exchange among a plurality of extension terminals 2 written in the application program is written. Moreover, when the simulation mode is set, the CPU 14A allows the display 30 of the maintenance terminal 3A to display the model including a plurality of extension terminals 2 and the whole private branch exchange apparatus 1A, and allows the maintenance terminal 3A to operate based on the simulation program stored in the storage section 15A and to execute the control process contents described in the application program with respect to the model displayed in the display 30.

Therefore, when the test operator only connects the maintenance terminal 3A to the private branch exchange apparatus 1A, operates the maintenance terminal 3A and sets the simulation mode, it is possible to reproduce and check the operation state of the model of a trouble generated time on the display screen. Therefore, it is unnecessary to acquire function setting contents of the trouble generated time, construct any system, or check operation contents of a plurality of extension terminals 2. Thereby, a reproduction test of the trouble generated time can be performed without requiring much time or labor. Moreover, even when the extension terminals 2 and lines do not actually exist, the reproduction test can easily be performed anywhere and anytime.

Furthermore, according to the first embodiment, the test operator may only perform the mode changeover operation by the maintenance terminal 3A. Therefore, it is unnecessary to separately prepare an exclusive simulator, and an optimum reproduction test can inexpensively be performed using the existing private branch exchange apparatus 1A.

### Second Embodiment

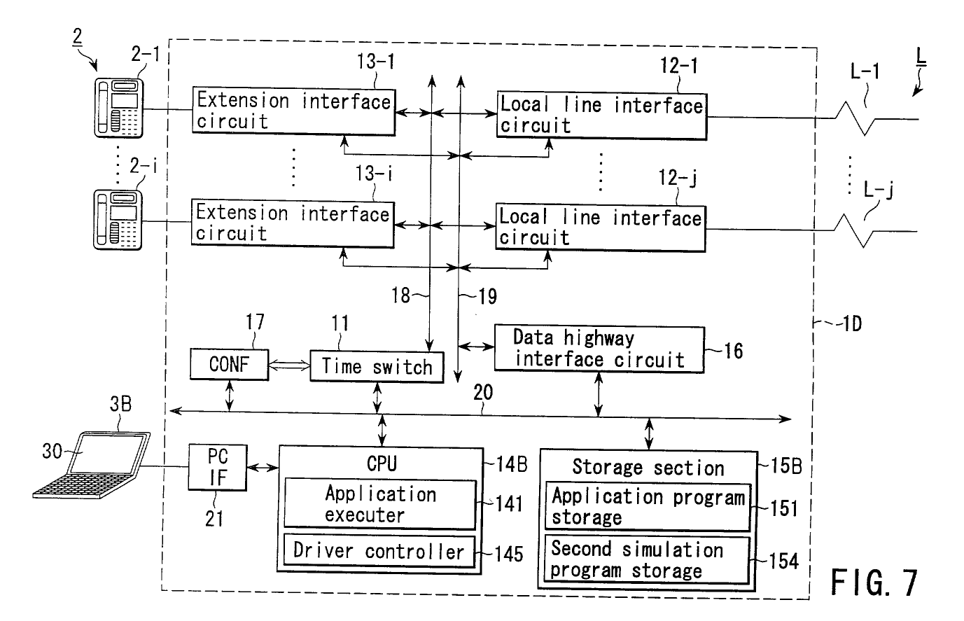

FIG. 7 is a schematic constitution diagram showing a second embodiment of the private branch exchange system to which the private branch exchange apparatus according to the present invention is applied. Additionally, in FIG. 7, the same components as those of FIG. 1 are denoted with the same reference numerals and detailed description thereof is omitted.

In a storage section 15B of the second embodiment, the application program storage 151 and a second simulation program storage 154 are disposed. Moreover, a CPU 14B is connected to the computer interface section (PCIF) 21.

This computer interface section 21 is connected to a maintenance terminal 3B if necessary. The computer interface section 21 performs an interface operation concerning the connected maintenance terminal 3B. The interface operation includes the extraction of the output signal from the maintenance terminal 3B, state monitor of the maintenance terminal 3B, and sending of various signals to the maintenance terminal 3B. Moreover, the computer interface section 21 transmits/receives various types of control information on the interface operation with the CPU 14B.

In the second simulation program storage 154 of the storage section 15B, there is stored the simulation program in which the step of allowing the maintenance terminal 3B to perform the control process concerning the exchange between the extension terminals 2, or between the extension terminal 2 and local line L is written.

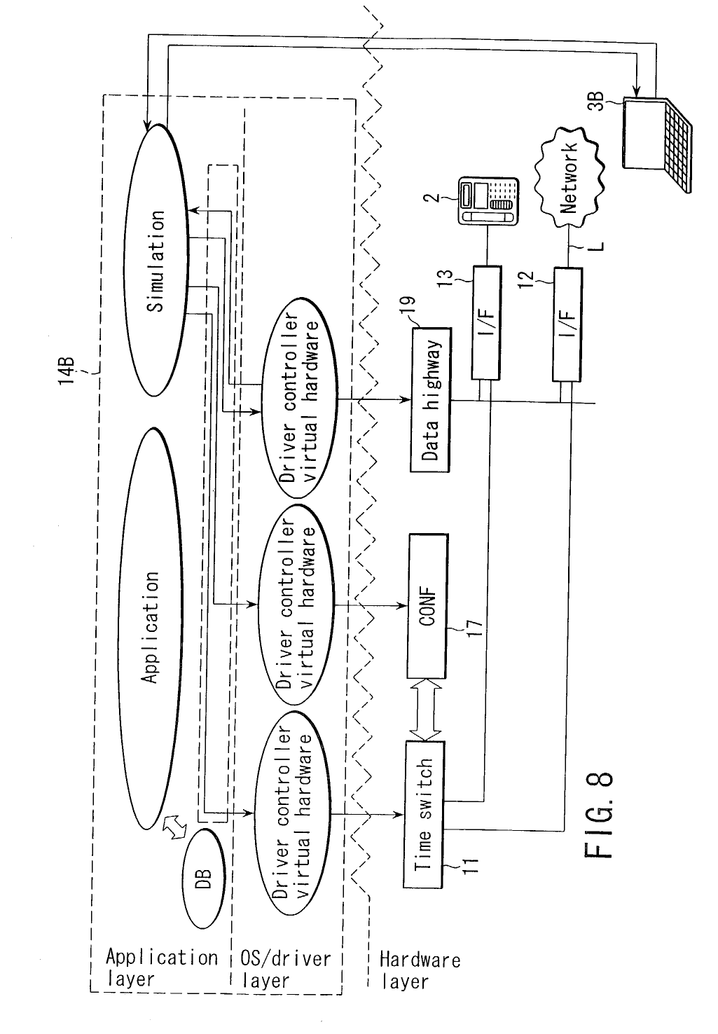

On the other hand, as shown in FIG. 8, the maintenance terminal 3B includes a simulation operation execution function of operating based on the simulation program stored in the second simulation program storage 154 of the storage section 15B instead of the CPU 14B and executing the control process concerning the exchange between the extension terminals 2, or between the extension terminal 2 and local line L, when the simulation mode is set.

The CPU 14B includes the application executor 141, and a driver controller 145. The application executor 141 performs the process based on the application program stored in the application program storage 151 of the storage section 15B, overall controls the time switch 11, local line interface circuits 12 and extension interface circuits 13, and realizes the operation of a private branch exchange apparatus 1B.

The driver controller 145 transmits/receives the data with the application executor 141 or the maintenance terminal 3B via the OS/driver layer.

Furthermore, the CPU 14B is connected to the maintenance terminal 3B, and raises a flag indicating the simulation mode and enters a standby state, when the simulation mode is designated by the operation of the maintenance terminal 3B.

An operation of the private branch exchange apparatus 1B constituted as described above will next be described.

### Usual Simulation Operation

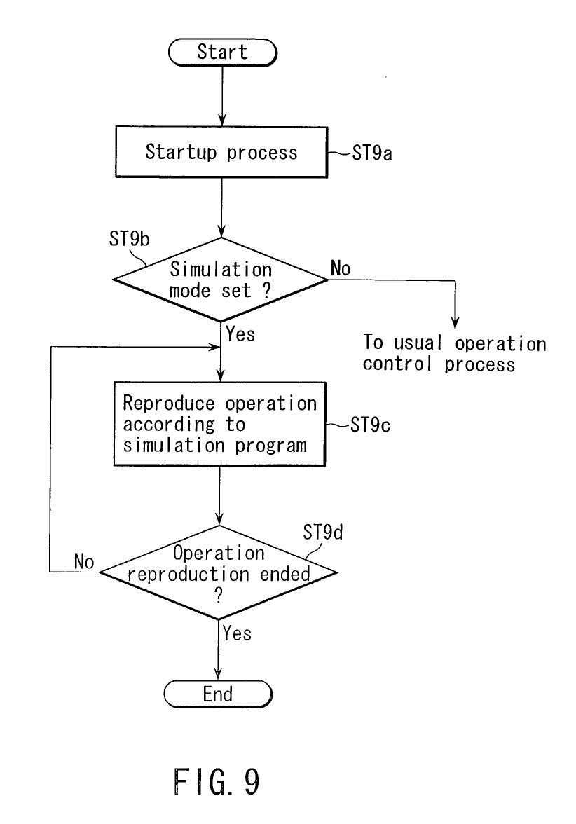

The maintenance terminal 3B connected to the private branch exchange apparatus 1B starts a control process shown in FIG. 9.

When this control process starts, the maintenance terminal 3B first executes the known startup process (step ST9a).

Subsequently, the maintenance terminal 3B checks the state of the CPU 14B, and judges whether or not the simulation mode is set (step ST9b).

Then, when the usual operation mode is set, the maintenance terminal 3B shifts to an operation control process for realizing the ordinary operation.

On the other hand, when the simulation mode is set, the maintenance terminal 3B executes the following process based on the simulation program stored in the second simulation program storage 154 of the storage section 15B.

That is, the maintenance terminal 3B reproduces the operation concerning the exchange between the extension terminals 2, or between the extension terminal 2 and local line L in accordance with the contents of the simulation program (step ST9c). During this reproduction of the operation, the maintenance terminal 3B selectively executes any one of a series of operation control step based on the simulation program and an operation control step designated by the test operator's operation.

Subsequently, the maintenance terminal 3B judges whether or not the reproduction operation has been completed, and repeatedly executes the process of steps ST9c and 9d until the operation is completed.

Subsequently, when the reproduction operation is completed, the maintenance terminal 3B ends the process.

### Conference Call Operation

Additionally, to perform a conference talking in the extension terminal 2-2 as a key station, sub stations are generally called in the following step.

That is, the speaker of the extension terminal 2-2 first presses “conference button” disposed on the extension terminal 2-2, while calling the extension terminal 2-1 as a first sub station. Then, the conference circuit 17 of the private branch exchange apparatus 1B sends the hold tone to the extension terminal 2-1, and sends a dial tone to the extension terminal 2-2. In this state, when the speaker of the extension terminal 2-2 dials a telephone number of the extension terminal 2-4 as a second sub station, the CPU 14B of the private branch exchange apparatus 1B starts calling the extension terminal 2-4 based on the dial-inputted telephone number. When the speaker of the extension terminal 2-4 answers this call, the private branch exchange apparatus 1B connects the extension terminal 2-4 to the extension terminal 2-2 and brings the terminals into the talking state. When the talking state with the extension terminal 2-4 is established, the speaker of the extension terminal 2-2 again presses the above-described “conference button”. Then, the private branch exchange apparatus 1B connects the extension terminals 2-1, 2-2, 2-4 to one another via the conference circuit 17 and brings the terminals into a three-speakers conference talking state.

However, the above-described step has to be performed until reaching a maximum conference circuit number. Therefore, the key station has to perform the same number of operations as that of terminals to be engaged in the conference, and much time is required.

To solve the problem, in the second embodiment, a series of operation step of performing the connection of the extension terminals 2 to the conference circuit 17 is written in the simulation program stored in the second simulation program storage 154 of the storage section 15B. Subsequently, when the test operator operates the maintenance terminal 3B to designate the connection to the conference circuit 17, the maintenance terminal 3B automatically repeats performing the connection process of a plurality of extension terminals 2 to the conference circuit 17 according to the simulation program stored in the second simulation program storage 154. Therefore, the maximum number of extension terminals 2 can be connected to the conference circuit 17.

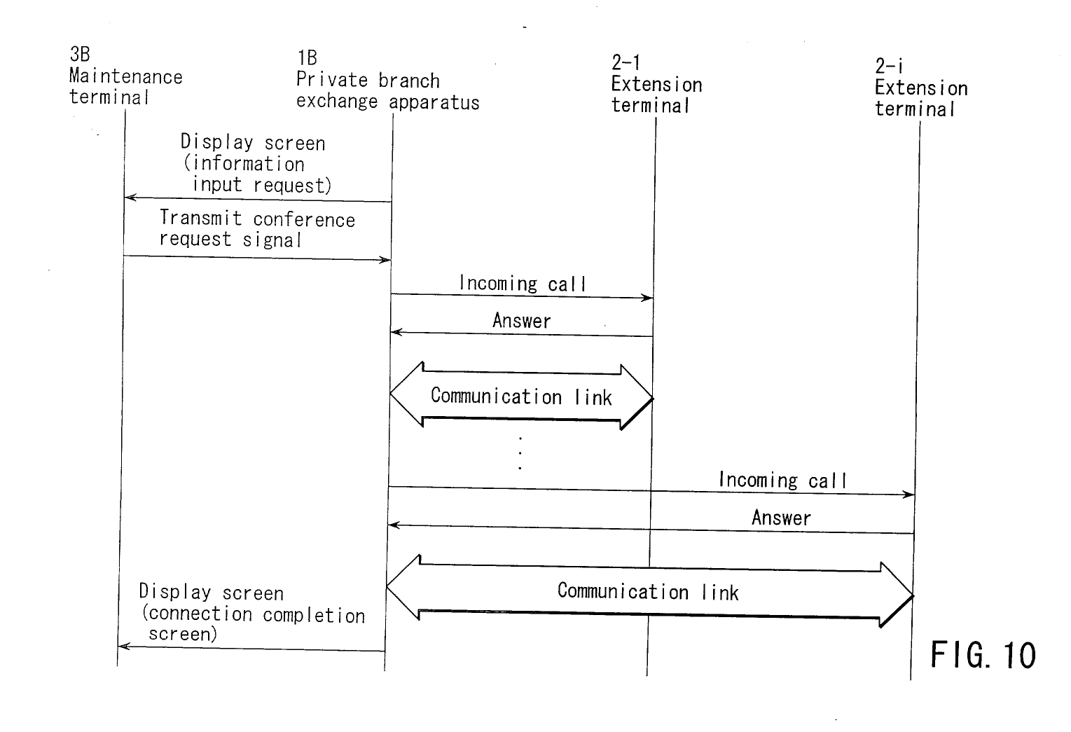

That is, as shown in FIG. 10, the test operator follows a guide of a request screen downloaded from the private branch exchange apparatus 1B, and uses the maintenance terminal 3B to input necessary items concerning the simulation. The necessary items to be inputted include information indicating the conference talking, the number of the conference circuit 17, and the extension number of the extension terminal 2 to be connected to the conference circuit 17. Subsequently, when the input of these necessary items ends, a conference request signal including these information is transmitted to the private branch exchange apparatus 1B.

Upon receiving the conference request signal, the private branch exchange apparatus 1B first calls the extension terminal 2-1. Subsequently, when the extension terminal 2-1 answers this incoming call, the private branch exchange apparatus 1B connects the extension terminal 2-1 to the conference circuit 17, and forms a communication link. This step is repeatedly performed up to the extension terminal 2-i.

When the connection of all the extension terminals 2-1 to 2-i to the conference circuit 17 is completed, the private branch exchange apparatus 1B transmits information of the completion to the maintenance terminal 3B, and allows the display 30 to display the information.

In the state of connection of the maximum number of extension terminals 2, the test operator sees the display 30 of the maintenance terminal 3B, and can thereby confirm the operation states of all the extension terminals 2 connected to the private branch exchange apparatus 1B, and path and operation states of the time switch 11.

As described above, in the second embodiment, in the second simulation program storage 154 of the storage section 15B disposed in the private branch exchange apparatus 1B, there is stored the simulation program in which the step of executing the control process concerning the exchange among a plurality of extension terminals 2 by the maintenance terminal 3B disposed outside is written. Moreover, when the simulation mode is set, instead of the CPU 14B, the maintenance terminal 3B operates based on the simulation program stored in the second simulation program storage 154 and executes the control process concerning the exchange among a plurality of extension terminals 2. Thereby, regardless of the contents of data setting, and operation order of the extension terminals 2, the maintenance terminal 3B can control and operate the private branch exchange apparatus 1B as if the intended service were realized.

Therefore, the test operator may only connect the maintenance terminal 3B to the private branch exchange apparatus 1B, and designate the simulation mode. It is unnecessary to travel to installation positions of the extension terminals 2 and operate the terminals. Moreover, even if the test operator does not know the data setting contents, the test of a hardware part to check can easily be performed. Thereby, the operational burdens by the test are remarkably reduced, the time required for the test is shortened, test efficiency is enhanced, and it is possible to conduct an accurate test with a high reliability.

Moreover, in the second embodiment, a series of operation step of connecting a plurality of extension terminals 2 to the conference circuit 17 is written beforehand in the simulation program stored in the second simulation program storage 154 of the storage section 15B. Moreover, the maintenance terminal 3B automatically repeats performing the connection process of a plurality of extension terminals 2 to the conference circuit 17 according to the simulation program stored in the second simulation program storage 154 during the simulation mode.

Therefore, the test operator may only connect the maintenance terminal 3B to the private branch exchange apparatus 1B, operate the maintenance terminal 3B and designate the connection of a plurality of extension terminals 2 to the conference circuit 17. In this case, it is unnecessary to operate the number of extension terminals 2 to be connected to the conference circuit 17. This largely reduces the operational burdens by the test, additionally shortens the time required for the test and enhances the test efficiency. It is possible to perform the accurate test with the high reliability.

### Third Embodiment

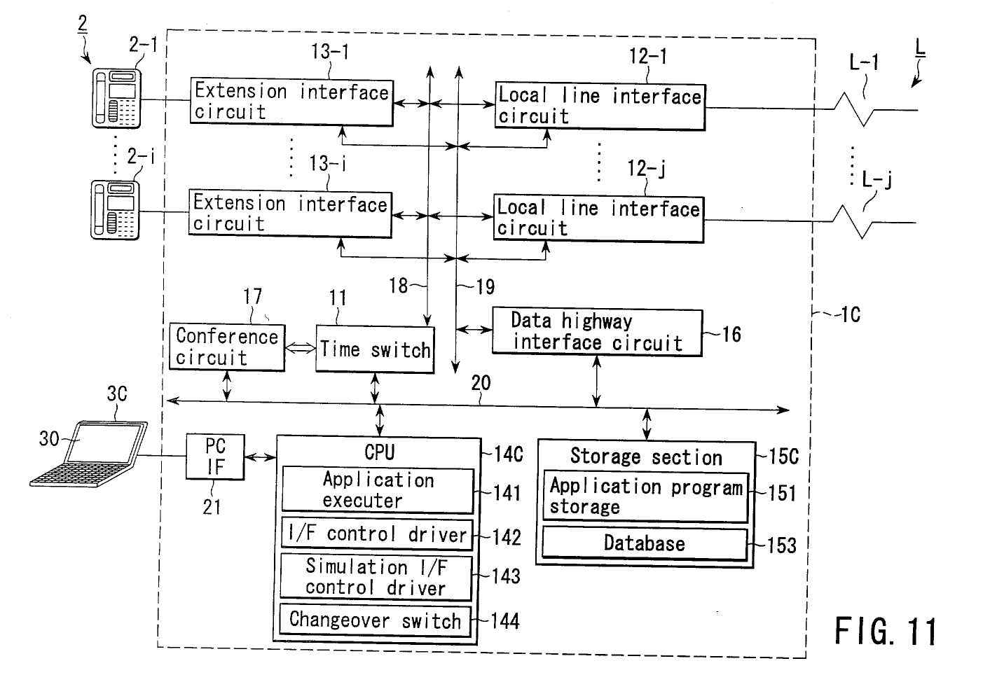

FIG. 11 is a schematic constitution diagram showing a third embodiment of the private branch exchange system to which the private branch exchange apparatus according to the present invention is applied. Additionally, in FIG. 11, the same components as those of FIG. 1 are denoted with the same reference numerals and the detailed description thereof is omitted.

That is, in a storage section 15C in the third embodiment, only the application program storage 151 and database 153 are disposed.

The simulation interface control driver 143 of a CPU 14C transfers the application program stored in the application program storage 151 to a maintenance terminal 3C in response to a request from the maintenance terminal 3C, when the simulation mode is designated.

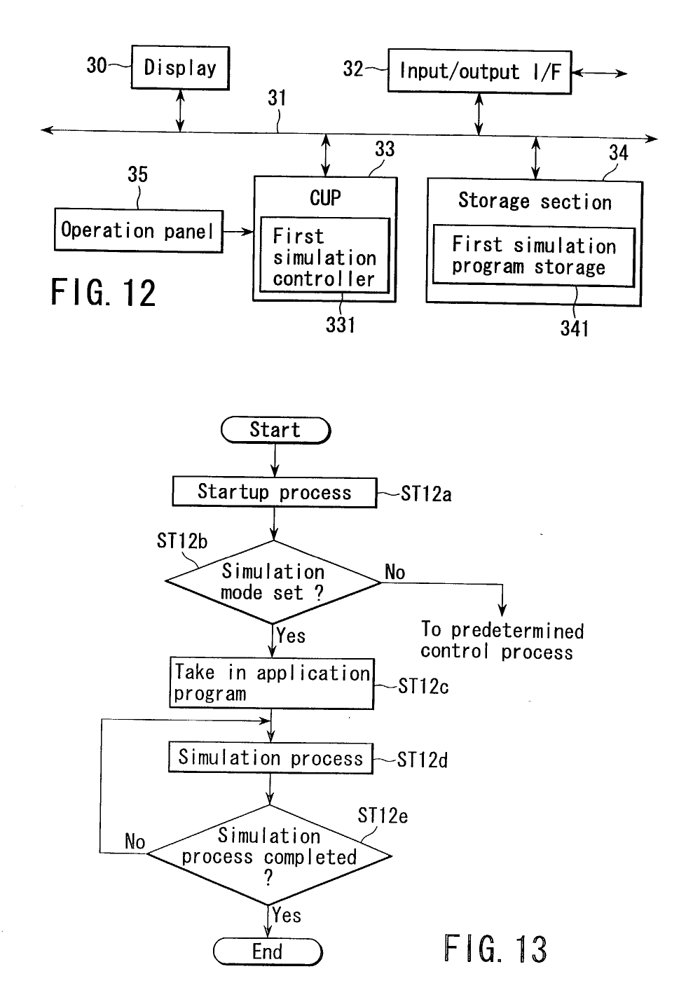

FIG. 12 is a block diagram showing a concrete constitution of the maintenance terminal 3C.

In FIG. 12, the display 30, an input/output interface section 32, a CPU 33, and a storage section 34 are connected on a data bus 31. Moreover, the CPU 33 is connected to an operation panel 35.

The input/output interface section 32 is connected to a private branch exchange apparatus 1C if necessary. The input/output interface section 32 transmits/receives the data with the private branch exchange apparatus 1C based on the control of the CPU 33.

The CPU 33 executes a process based on the program stored in the storage section 34, thereby overall controls the display 30 and input/output interface section 32, and realizes the operation of the maintenance terminal 3C.

The operation panel 35 has an input device such as a key switch group, and accepts various instruction inputs to the CPU 33 by the user under the control of the CPU 33.

Additionally, the storage section 34 of the third embodiment includes a first simulation program storage 341. In the first simulation program storage 341, there is stored the simulation program in which a step of simulating control process contents concerning the exchange among a plurality of extension terminals 2 written in the application program of the application program storage 151 of the private branch exchange apparatus 1C is written.

On the other hand, the CPU 33 includes a first simulation controller 331. The first simulation controller 331 displays the model indicating at least a plurality of extension terminals 2 and the whole private branch exchange apparatus 1C in the display 30 in accordance with simulation designation information by a user designation input operation using the operation panel 35. Subsequently, the controller operates based on the simulation program stored in the first simulation program storage 341 of the storage section 34, takes the application program from the private branch exchange apparatus 1C, and executes the control process contents written in the application program with respect to the model displayed in the display 30.

An operation of the maintenance terminal 3C constituted as described above will next be described.

When the maintenance terminal 3C is connected to the private branch exchange apparatus 1C, the CPU 33 of the maintenance terminal 3C starts a control process shown in FIG. 13.

When this control process starts, the CPU 33 first executes the known startup process (step ST12a), and subsequently judges whether or not the simulation mode is set (step ST12b).

Then, when the usual operation mode is set, the CPU 33 shifts to the control process for realizing the ordinary operation of the maintenance terminal 3C.

On the other hand, when the simulation mode is set, the CPU 33 executes the following process based on the simulation program stored in the first simulation program storage 341 of the storage section 34.

That is, the CPU 33 takes in the application program from the private branch exchange apparatus 1C (step ST12c), displays the model indicating the whole private branch exchange apparatus 1C in the display 30, and executes the written contents of the application program acquired with respect to the model (step ST12d).

Subsequently, the CPU 33 judges whether or not the simulation process has been completed, and repeatedly executes the process of the steps ST12d and ST12e until the process is completed.

Subsequently, the CPU 33 ends the process, when the simulation process is completed.

Even in this third embodiment, an action/effect similar to that of the first embodiment is obtained, and further the process burden of the private branch exchange apparatus 1C and storage capacity of the storage section 15C can be reduced as compared with the first embodiment.

### Fourth Embodiment

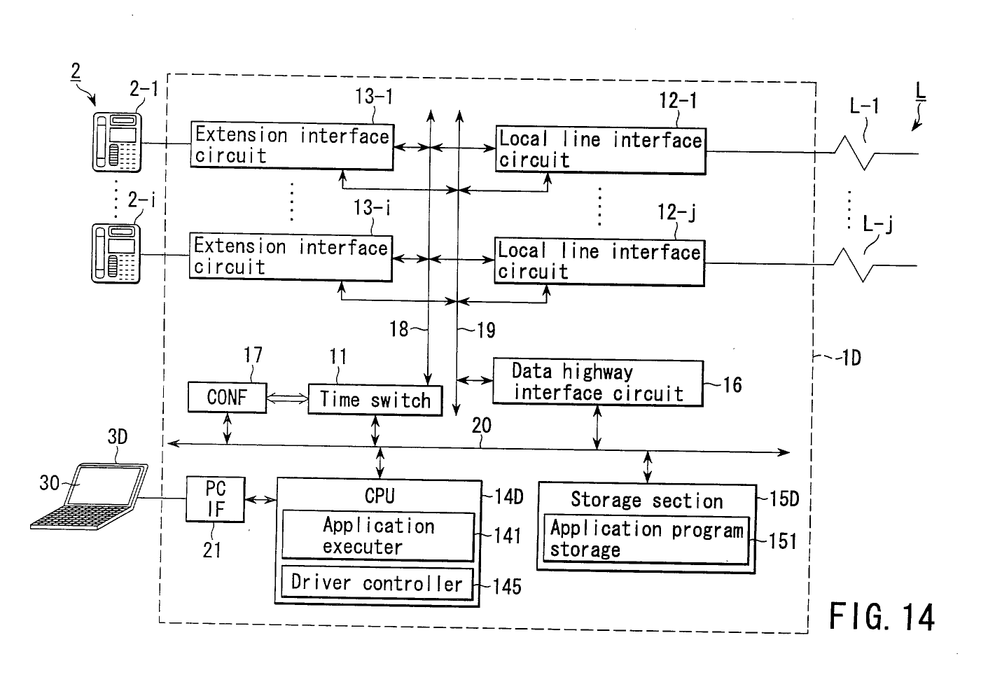

FIG. 14 is a schematic constitution diagram showing a fourth embodiment of the private branch exchange system to which the private branch exchange apparatus according to the present invention is applied. Additionally, in FIG. 14, the same components as those of FIG. 7 are denoted with the same reference numerals and the detailed description thereof is omitted.

That is, in a storage section 15D in the fourth embodiment, only the application program storage 151 is disposed.

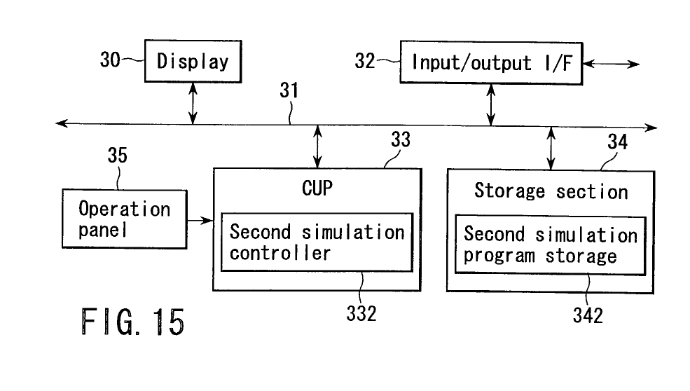

FIG. 15 is a block diagram showing a concrete constitution of a maintenance terminal 3D. Additionally, in FIG. 15, the same components as those of FIG. 12 are denoted with the same reference numerals and the detailed description thereof is omitted.

That is, in the storage section 34 of the fourth embodiment, a second simulation program storage 342 is disposed. In the second simulation program storage 342, there is stored the simulation program in which a step of performing the control process concerning the exchange between the extension terminals 2, and between the extension terminal 2 and local line L is written.

On the other hand, the CPU 33 includes a second simulation controller 332. The second simulation controller 332 operates based on the simulation program stored in the second simulation program storage 342 of the storage section 34 in accordance with the simulation designation information by the user designation input operation using the operation panel 35 and executes the control process concerning the exchange between the extension terminals 2, and between the extension terminal 2 and local line L.

Even in this fourth embodiment, the action/effect similar to that of the second embodiment is obtained. Furthermore, as compared with the second embodiment, the process burden of a private branch exchange apparatus 1D, and the storage capacity of the storage section 15D can be reduced.

### Other Embodiments

Additionally, the present invention is not limited to the above-described embodiments. For example, in the respective embodiments, the private branch exchange apparatus including the extension terminals has been described as an example. In addition, the present invention can also be applied to a communication apparatus such as an UnPBX in which the extension terminals are connected to a general-purpose personal computer, and a personal computer for controlling other hardware apparatuses.

Moreover, the control object is not limited to the extension terminal, and may be arbitrary.

Furthermore, in the first and third embodiments, an example in which the usual and simulation modes are selectively changed by the changeover switch 144 in the software process has been described. However, the present invention is not limited to this. While the control over the exchange among a plurality of extension terminals 2 is performed in the usual mode, the maintenance terminal 3A, 3B, 3C, 3D operates based on the simulation program in response to the switch operation from the outside and may judge whether or not to execute the control process contents written in the application program with respect to the model displayed in the display.

In this case, when the trouble is generated in a usual time, the test operator connects the private branch exchange apparatus 1A, 1B, 1C, 1D to the maintenance terminal 3A, 3B, 3C, 3D, and only designates the simulation mode. Then, while the private branch exchange apparatus 1A, 1B, 1C, 1D is operated, the reproduction test can be conducted. Additionally, since the usual mode is not stopped, the influence on the call can remarkably be reduced.

Moreover, in the above-described embodiments, an example in which the maintenance terminals 3A, 3B, 3C, 3D set the simulation mode has been described. However, the present invention is not limited to this example, and the simulation mode may be set by the terminals other than the maintenance terminals 3A, 3B, 3C, 3D.

Furthermore, in the second embodiment, an example in which the second simulation program storage 154 is disposed in the private branch exchange apparatus 1B has been described. However, the present invention is not limited to this example, and the simulation program storage may be disposed in the maintenance terminal 3B.

Additionally, the type and constitution of the private branch exchange apparatus, the type of the extension terminal, the type of the maintenance terminal, the type of the model, and the respective control steps and contents can also variously be modified and implemented without departing from the scope of the present invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A communication apparatus which executes a predetermined communication process and controls a control object related with communication based on an application program stored in first storing means, the communication apparatus comprising:
connecting means for connecting an extend control apparatus disposed outside the apparatus and including a display;
second storing means for storing a simulation program in which a step of allowing said extend control apparatus to simulate control process contents written in said application program is written; and
simulation controlling means for making said extend control apparatus display a model indicating said control object in the display, and execute the control process contents written in the application program with respect to the model displayed in said display in accordance with the simulation program, when a simulation by said extend control apparatus is designated.

2. A private branch exchange apparatus which connects a plurality of extension terminals via extension lines, and executes a control over an exchange among said plurality of extension terminals based on an application program stored in first storing means, the private branch exchange apparatus comprising:
connecting means for connecting an extend control apparatus disposed outside the apparatus and including a display;
second storing means for storing a simulation program in which a step of allowing said extend control apparatus to simulate control process contents concerning the exchange written in said application program is written; and
simulation controlling means for making said extend control apparatus display a model indicating at least said plurality of extension terminals in the display, and execute the control process contents written in the application program with respect to the model displayed in said display in accordance with the simulation program, when a simulation by said extend control apparatus is designated.

3. The private branch exchange apparatus according to claim 2, wherein said simulation controlling means includes:
a first mode in which the control over the exchange among said plurality of extension terminals is executed based on the application program;
a second mode in which said extend control apparatus executes the control process contents written in the application program with respect to the model displayed in said display in accordance with the simulation Program; and
mode selecting means for selectively executing said first mode and said second mode in response to a designation operation from the outside.

4. The private branch exchange apparatus according to claim 2, wherein said simulation controlling means includes switching means for switching whether or not to make said extend control apparatus execute the control process contents written in the application program with respect to the model displayed in said display in accordance with the simulation program in response to a switch operation from the outside, while the control over the exchange among said plurality of extension terminals is executed based on the application program.

5. A communication apparatus which executes a predetermined communication process, and controls a predetermined control object related with communication, the communication apparatus comprising:
connecting means for connecting an extend control apparatus disposed outside the apparatus;
storing means for storing a simulation program in which a step of executing said communication process in said extend control apparatus is written; and
simulation controlling means for making said extend control apparatus execute a control process of said control object in accordance with the simulation program, when the control process of said control object by the extend control apparatus connected to said connection means is designated.

6. A private branch exchange apparatus which connects a plurality of extension terminals via extension lines, and executes a control over an exchange among said plurality of extension terminals, the private branch exchange apparatus comprising:
connecting means for connecting an extend control apparatus disposed outside the apparatus;
storing means for storing a simulation program in which a step of executing a control process concerning the exchange among said plurality of extension terminals in said extend control apparatus is written; and
simulation controlling means for making said extend control apparatus execute the control process concerning the exchange among said plurality of extension terminals in accordance with the simulation program, when said control process by said extend control apparatus is designated.

7. The private branch exchange apparatus according to claim 6, further comprising: a conference circuit selectively connected to said plurality of extension terminals so that a conference call is possible,
wherein a series of operation step of connecting said plurality of extension terminals to said conference circuit is described in the simulation program stored in said storing means, and
said simulation controlling means allows said extend control apparatus to control the connection of said plurality of extension terminals to said conference circuit based on the simulation program, when the control process by said extend control apparatus is designated.

8. A maintenance terminal apparatus connected to a private branch exchange apparatus which connects a plurality of extension terminals via extension lines and executes a control over an exchange among said plurality of extension terminals based on an application program stored in first storing means, and including a display, the maintenance terminal apparatus comprising:
second storing means for storing a simulation program in which a step of simulating control process contents concerning the exchange among said plurality of extension terminals written in said application program is written; and
simulation controlling means for displaying a model indicating at least said plurality of extension terminals in said display, and executing the control process contents written in the application program with respect to the model displayed in said display in accordance with the simulation program, when a simulation is designated.

9. A maintenance terminal apparatus connected to a private branch exchange apparatus which connects a plurality of extension terminals via extension lines and executes a control over an exchange among said plurality of extension terminals, the maintenance terminal apparatus comprising:
storing means for storing a simulation program in which a step of executing a control process concerning the exchange among said plurality of extension terminals is written; and
simulation controlling means for executing the control process concerning the exchange among said plurality of extension terminals in accordance with the simulation program, when a simulation is designated.

10. A communication apparatus which executes a predetermined communication process and controls a control object related with communication based on an application program stored in first storing section, the communication apparatus comprising:
a connecting section which connects an extend control apparatus disposed outside the apparatus and including a display;
a second storing section which stores a simulation program in which a step of simulating control process contents written in said application program in said extend control apparatus is written; and
a simulation controlling section which makes said extend control apparatus display a model indicating said control object in the display, execute the control process contents written in the application program with respect to the model displayed in said display in accordance with the simulation program, when a simulation by said extend control apparatus is designated.

11. A private branch exchange apparatus which connects a plurality of extension terminals via extension lines and executes a control over an exchange among said plurality of extension terminals based on an application program stored in a first storing section, the private branch exchange apparatus comprising:
a connecting section which connects an extend control apparatus disposed outside the apparatus and including a display;
a second storing section which stores a simulation program in which a step of simulating control process contents concerning the exchange among said plurality of extension terminals written in said application program in said extend control apparatus is written; and
a simulation controlling section which makes said extend control apparatus display a model indicating at least said plurality of extension terminals in the display, execute the control process contents written in the application program with respect to the model displayed in said display in accordance with the simulation program, when a simulation by said extend control apparatus is designated.

12. The private branch exchange apparatus according to claim 11, wherein said simulation control section includes:
a first mode in which the control over the exchange among said plurality of extension terminals is executed based on the application program;
a second mode in which said extend control apparatus executes the control process contents written in the application program with respect to the model displayed in said display in accordance with the simulation program; and
a mode selecting section which selectively executes said first mode and said second mode in response to a designation operation from the outside.

13. The private branch exchange apparatus according to claim 11, wherein said simulation control section includes a switching section which switches whether or not to execute the control process contents written in the application program with respect to the model displayed in said display in accordance with the simulation program in response to a switch operation from the outside, while the control over the exchange among said plurality of extension terminals is executed based on the application program.

14. A communication apparatus which executes a predetermined communication process, and controls a predetermined control object related with communication, the communication apparatus comprising:
a connecting section which connects an extend control apparatus disposed outside the apparatus;
a storing section which stores a simulation program in which a step of executing said communication process in said extend control apparatus is written; and
a simulation controlling section which makes said extend control apparatus execute a control process of said control object in accordance with the simulation program, when the control process of said control object by the extend control apparatus connected to said connection section is designated.

15. A private branch exchange apparatus which connects a plurality of extension terminals via extension lines and executes a control over an exchange among said plurality of extension terminals, the private branch exchange apparatus comprising:
a connecting section which connects an extend control apparatus disposed outside the apparatus;
a storing section which stores a simulation program in which a step of executing a control process concerning the exchange among said plurality of extension terminals in said extend control apparatus is written; and
a simulation controlling section which makes said extend control apparatus execute the control process concerning the exchange among said plurality of extension terminals in accordance with the simulation program, when said control process by said extend control apparatus is designated.

16. The private branch exchange apparatus according to claim 15, further comprising: a conference circuit selectively connected to said plurality of extension terminals so that a conference call is possible,
wherein a series of operation step of connecting said plurality of extension terminals to said conference circuit is described in the simulation program stored in said storing section, and
said simulation controlling section allows said extend control apparatus to control the connection of said plurality of extension terminals to said conference circuit based on the simulation program, when the control process by said extend control apparatus is designated.

17. A maintenance terminal apparatus connected to a private branch exchange apparatus which connects a plurality of extension terminals via extension lines and executes a control over an exchange among said plurality of extension terminals based on an application program stored in a first storing section, and including a display, the maintenance terminal apparatus comprising:
a second storing section which stores a simulation program in which a step of simulating control process contents concerning the exchange among said plurality of extension terminals written in said application program is written; and
a simulation controlling section which displays a model indicating at least said plurality of extension terminals in said display, executes the control process contents written in said application program with respect to the model displayed in said display in accordance with the simulation program, when a simulation is designated.

18. A maintenance terminal apparatus connected to a private branch exchange apparatus which connects a plurality of extension terminals via extension lines and executes a control over an exchange among said plurality of extension terminals, the maintenance terminal apparatus comprising:
a storing section which stores a simulation program in which a step of executing a control process concerning the exchange among said plurality of extension terminals in said extend control apparatus is written; and
a simulation controlling section which execute the control process concerning the exchange among said plurality of extension terminals in accordance with the simulation program, when a simulation is designated.

19. A simulation method for use in a communication apparatus which executes a predetermined communication process and controls a control object related with communication based on an application program stored in a first storing section, the communication apparatus comprising:
a connecting section which connects an extend control apparatus disposed outside the apparatus and including a display; and a second storing section to store a simulation program in which a step of simulating control process contents written in said application program in said extend control apparatus is written; the simulation method comprising:
detecting a simulation by said extend control apparatus is designated, to generate a detection signal; and
causing said extend control apparatus to display a model indicating said control object in the display, to execute the control process contents written in the application program with respect to the model displayed in said display in accordance with the simulation program in response to the detection signal.

20. A simulation method for use in a private branch exchange apparatus which connects a plurality of extension terminals via extension lines and executes a control over an exchange among said plurality of extension terminals based on an application program stored in a first storing section, the private branch exchange apparatus comprising:
a connection section which connects an extend control apparatus disposed outside the apparatus and including a display; and a second storing section to store a simulation program in which a step of simulating control process contents concerning the exchange written in said application program in said extend control apparatus is written, said simulation method comprising:
detecting a simulation by said extend control apparatus is designated, to generate a detection signal; and
causing said extend control apparatus to display a model indicating at least said plurality of extension terminals in the display, to execute the control process contents written in the application program with respect to the model displayed in said display in accordance with the simulation program in response to the detection signal.

21. A simulation method for use in a communication apparatus which executes a predetermined communication process, and controls a predetermined control object related with communication, the communication apparatus comprising:
a connection section which connects an extend control apparatus disposed outside the apparatus; and a storing section to store a simulation program in which a step of executing said control process in said extend control apparatus is written; said simulation method comprising:
detecting the control process of said control object by said extend control apparatus is designated, to generate a detection signal; and
causing said extend control apparatus to execute the control process of said control object in accordance with the simulation program in response to the detection signal.

22. A simulation method for use in a private branch exchange apparatus which connects a plurality of extension terminals via extension lines and executes a control over an exchange among said plurality of extension terminals, the private branch exchange apparatus comprising:
a connection section which connects an extend control apparatus disposed outside the apparatus; and a storing section to store a simulation program in which a step of executing a control process concerning the exchange among said plurality of extension terminals in said extend control apparatus is written; said simulation method comprising:
detecting the control process by said extend control apparatus is designated, to generate a detection signal; and
causing said extend control apparatus to execute the control process concerning the exchange among said plurality of extension terminals in accordance with the simulation program in response to the detection signal.
